(19) United States
(12) Patent Application Publication
(10) Pub. No.: US 2010/0187456 A1
(43) Pub. Date: Jul. 29, 2010

(54) Adjustment Device for an Open-Close Valve

(76) Inventors: Klaus-Peter Heer, Herxheim (DE); Volker Hirsch, Steinfeld (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/669,924

(22) PCT Filed: Jul. 16, 2008
(86) PCT No.: PCT/EP08/59316

§ 371 Date: Jan. 20, 2010

(30) Foreign Application Priority Data
Jul. 20, 2007 (DE) 10 2007 034 060.7

(51) Int. Cl. F16K 31/02

(52) U.S. Cl. 251/129.03

(57) ABSTRACT

An adjustment device for an open-close valve (1) has a pneumatic drive (2) which is aerated or de-aerated according to the presence or absence of a control voltage (Vs) which can be supplied by a control system (5). The valve (1) moves into an operating position when the drive is aerated, and into a safety position when the drive is de-aerated. The valve (1) is provided with an electro-pneumatic position regulator (8) for carrying out a partial stroke test. In order to reduce the technical demands of the invention, the electro-pneumatic position regulator (8) is directly connected to the pneumatic drive (2) with no interconnection of a magnetic valve controlled by the control voltage (Vs); the position regulator (8) is connected on the voltage supply side to the control voltage (Vs) which can be supplied by the control system (5), and is designed to de-aerate the pneumatic drive (2) if the power supply is interrupted; a routine for carrying out the partial stroke test, and a value for the set position of the valve (1) in the operating position are stored in the position regulator (8).

The invention relates to an actuating device for an on/off valve having a pneumatic drive which is pressurized or depressurized as a function of the presence or absence of a control voltage supplied by a control system and, when pressurized moves the valve to an operating position and, when depressurized, moves the valve to a safe position, and having an electropneumatic position regulator (8) which moves the valve temporarily over a part of its actuating movement to a nominal position and a partial stroke test in this case records the actual position of the valve and produces a pneumatic manipulated variable for the pneumatic drive as a function of the actual position and nominal position.

In one such actuating device, which is known from DE 10 2006 003 750 A1 or from DE 10 2005 004 477 A1, a pneumatic on/off valve, in particular an emergency shut-down (ESD) valve, is moved by means of a pneumatic drive either to an operating position, for example “on”, or to a safe position, for example “off”. A solenoid valve which is operated by a control voltage supplied from a control system connects the pneumatic drive to a compressed-air supply. In an emergency, the control voltage is switched off, in order to depressurize the pneumatic drive via the solenoid valve, as a result of which the valve is moved from the operating position to the safe position.

In order to allow the serviceability of the actuating device to be checked during the course of a partial stroke test, an additional position regulator is connected to the pneumatic drive. During the partial stroke test, the valve is moved by means of the position regulator from the operating position over a portion of its actuating movement, and is then moved back again. The position change is in this case so small that there is no need to interrupt ongoing operation of the installation in which the actuating valve is installed, and its operation is interfered with only insignificantly. During the partial stroke test, the actuating movement is recorded and stored.

In the case of the known actuating device, in addition to the solenoid valve, the position regulator is attached to the fitting comprising the valve and drive, as a further unit with corresponding wiring and pipework. In addition, an analog output assembly must be provided in the control system for operating the position regulator, which for example, supplies a 4-20 mA signal in order to transmit the nominal value for valve regulation. This not only involves a large amount of additional material complexity, but also a high additional financial cost. Furthermore, although the fitting can be tested by means of the position regulator and the partial stroke test that is carried by it, the solenoid valve requires a further test procedure, however.

Said problems have been solved to a minor extent by the actuating device which is known from DE 10 2005 004 477 A1, as cited above, in which the solenoid valve is integrated in the housing of the position regulator. However, the separate solenoid valve function is still required and an analog output assembly is required in the control system, in order to supply the nominal value for the position regulator. The test of the solenoid valve is likewise still required.

According to the invention, the problem is solved in that, in the case of the actuating device of the type specified initially, the position regulator is connected on the power supply side to the control voltage which can be supplied by the control system and is designed to depressurize the pneumatic drive in the occurrence of failure of the power supply and in that a routine for carrying out the partial stroke test and also a value for the nominal position of the valve in the operating position are stored in the position regulator.

The actuating device according to the invention has no solenoid valve whatsoever, its function being carried out by the position regulator. Furthermore, the position regulator automatically carries out the partial stroke test in order to identify any lack of freedom of movement or blockage of the valve at an early stage. In this case, the position regulator does not require a nominal value preset, for example in the form of a 4-20 mA signal, which means that, in this case, the control system also no longer requires any expensive analog output assembly. Instead of this, the value for the nominal position of the valve in its operating position is stored in the position regulator (programmed in). This nominal value is preferably a short distance away from the end stop of the valve in the operating position and, for example, is 97% of the end stop position. The position regulator continuously attempts to use the valve position corresponding to the nominal value for regulation, until a partial stroke test is demanded or the pneumatic drive is depressurized in an emergency, in order to move the valve to the safe position. In this case, position regulator diagnosis functions which are known for control valves (in contrast to on/of valves), such as the monitoring of the pneumatic leakage or the lack of freedom of movement of the fitting are used, thus further enhancing safety because the continuous regulation processes result in a test which is comparable to the partial stroke test being carried out permanently in the small-signal range.

Since there is no nominal value preset, for example in the form of a 4-20 mA signal, of the actuating device according to the invention this advantageously meets the requirements of some users/operators that the valve should not move to the safe position in the event of failure of the 4-20 mA nominal value signal for the position regulator.

The position regulator is fed with the same control voltage, in general a 24 V signal, as that which is also required in the prior art for the solenoid valve which allows the emergency shutdown function. The position regulator is therefore a complete replacement for this solenoid valve. If the control voltage is switched off, the position regulator (for example the SIEMENS SIPART PS2 position regulator, which is certified in accordance with SIL2) depressurizes the pneumatic drive, in the same way that this is done with the solenoid valve in the prior art. However, instead of two units attached to the fitting comprising the valve and drive, only the position regulator is required, and at the same time carries out the solenoid valve function. This simplifies the pipework as well as the attachment to the fitting, because only one unit now needs to be attached and connected. The cable which was originally required for the solenoid valve, and the power supply for it, can still be used for the position regulator.

Since the actuating device according to the invention no longer has a solenoid valve, there is, of course, also no longer any need to test it. In addition to this: because the pneumatic output stage of the position regulator, which is being operated all the time and regulates out small control discrepancies in the operating position of the valve, the risk of the pneumatic output valves of the position regulator “sticking” is considerably less than in the case of a solenoid valve which is operated in one position all the time.

The partial stroke test can be initiated manually via a control element on the position regulator, by a binary signal which, for example, is sent from the control system via a digital output to a binary input of the position regulator, or is initiated automatically by the position regulator at regular intervals, by means of a timer which is contained in the position regulator. In principle, the partial stroke test can also be started via an HART command (4-20 mA) from the control system, although this would require an analog output assembly there.

The position regulator can autonomously evaluate the partial stroke test, with the actual positions of the valve recorded during the partial stroke test being stored in a memory in the position regulator, for diagnosis purposes. The curve profile of the actual positions can then be read, for example, locally, via a Notebook with, for example, a PDM (Process Device Manager), and can be compared with a reference curve. After the test has been evaluated in an evaluation device in the position regulator, the test result can be signaled via a preferably binary signal output to the control system. However, the actual position reached during the partial stroke test can also be signaled via a position signaling device with contacts, or in the form of a proximity switch (for example a slot initiator). In addition, analog feedback of the position change of the valve is possible via, for example, a 4-20 mA output stage of the position regulator. Finally, if communication interfaces such as HART or fieldbus are present, the feedback can be provided to the control system via the communication interfaces. The test result can also be displayed on a position regulator display.

The availability of the actuating device according to the invention can also advantageously be even further improved in that a pressure monitor which is arranged in the compressed-air supply for the position regulator, is connected to a signal input of the position regulator, and in that the position regulator is designed to set the regulation when a minimum pressure is undershot, and to block the pressurization and depressurization of the pneumatic drive. Alternatively, a position limit-value signaling device for signaling an actual position of the valve other than the operating position can be connected to a signal input of the position regulator, and the position regulator can be designed to set the regulation if the position discrepancy is exceeded, and to block the pressurization and depressurization of the pneumatic drive. In the event of a disturbance in the compressed-air supply, resulting in the supply pressure being too low, the pneumatic output valves of the position regulator are closed, as a result of which the position regulator no longer unsuccessfully attempts to readjust the valve position but, instead of this, blocks the existing compressed air in the pneumatic drive and therefore prevents any further position change of the valve away from the operating position.

In order to explain the invention further, the following text refers to the figures of the drawing, in which:

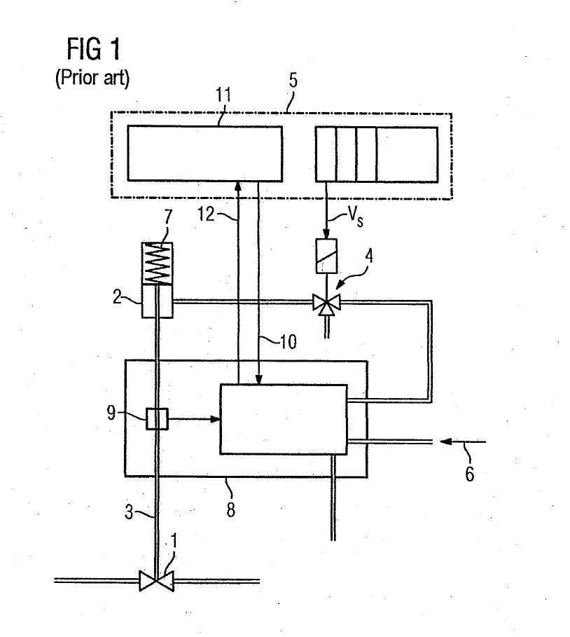

FIG. 1 shows an actuating device according to the prior art, and

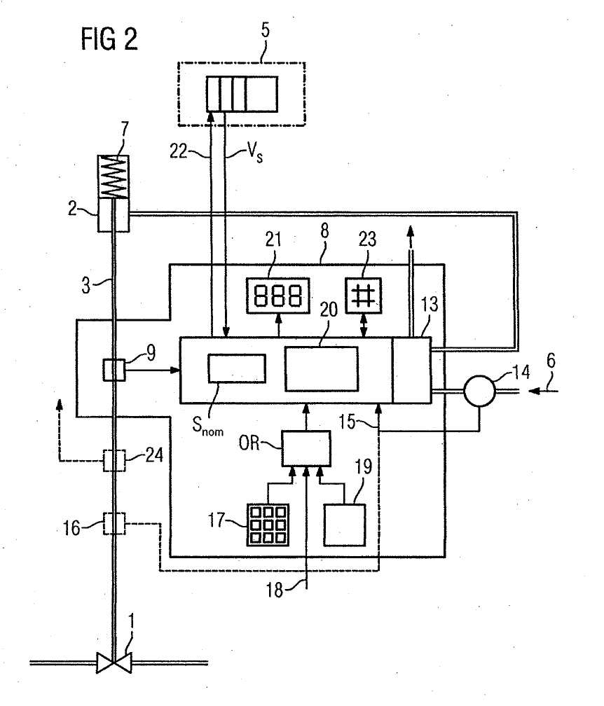

FIG. 2 shows one exemplary embodiment of the actuating device according to the invention.

The actuating device according to the prior art, as shown in FIG. 1, has an on/off valve 1 which can be moved by means of a pneumatic drive 2 via an actuating element 3, in this case in the form of a push rod, either to an operating position, for example “on” or to a safe position, for example “off”. A solenoid valve 4, which is operated by a control voltage V_{S} supplied from a control system 5, connects the pneumatic drive 2 to a compressed-air supply 6. In an emergency, the control voltage V_{S} is switched off, in order to depressurize the pneumatic drive 2 via the solenoid valve 4. The pneumatic drive 2 then has no pressure in it, and the actuating element 3 is moved with the valve 1, for example under the influence of a spring 7, from the operating position to the safe position.

In order to allow the serviceability of the actuating device to be checked in the course of a partial stroke test, an additional position regulator 8 is pneumatically connected between the solenoid valve 3 and the compressed-air supply 6. A position transmitter 9 records the actual position of the valve 1 at the actuating element 3 and supplies this to the position regulator 8, which sets a variable output pressure as the manipulated variable, as a function of the actual position and a predeterminable nominal position, in order to move the valve 1 to the nominal position via the pneumatic drive 2. In order to preset the nominal position, the position regulator 8 is connected via a communication link 10, for example a 4-20 mA line, to an analog output assembly 11 of the control system 5. During the partial stroke test, the valve 1 is moved by means of the position regulator 8 from the operating position over a portion of its actuating movement, and is then moved back again. The position change is in this case so small that the ongoing operation of the installation in which the valve 1 is installed may not be interrupted, and is disturbed only insignificantly. During the partial stroke test, which, for example, is initiated automatically by the control system 5 at regular time intervals via the communication link 10 or manually via a control element on the position regulator 8, the actuating movement of the valve 1 is recorded, possibly stored, and is signaled via a further communication link 12 to the control system 5, where the partial stroke test is evaluated.

The test is assessed as being successful as a function of a predetermined position change being achieved within a minimum time, or as a function of the position change reaching a minimum value within a predetermined time. This makes it possible to detect when the valve 4 is blocked or is reacting too slowly.

The exemplary embodiment of the actuating device according to the invention, as illustrated in FIG. 2, differs from the device according to the prior art, as shown in FIG. 1, in that the position regulator 8 also carries out the function of the solenoid valve, which is not present in this case, and is connected to the pneumatic drive 2 without the interposition of the solenoid valve. The value Sₙₒₘ for the nominal position of the valve 1 in its operating position is stored in the position regulator 8, as a result of which there is no need for the control system 5 to preset a nominal value. The position regulator 8 is fed with the control voltage V_{S} from the control system 5. If the control voltage V_{S} fails or if it is switched off, then the position regulator 8 depressurizes the pneumatic drive 2 via its pneumatic output stage 13, as a result of which the valve 1 moves to the safe position. As long as the control voltage V_{S} is applied to the position regulator 8, this regulates the valve position corresponding to the stored nominal value sₙₒₘ, which is a short distance 5, for example, 3% away from the final position of the valve 1 in its operating position. The regulation is therefore always active, thus reducing the risk of “sticking” of the pneumatic output valves in the output stage 13 of the position regulator 8. In order to prevent the valve 1 from being moved too far away from the operating position because of the lack of regulation capability which would then exist, in the event of a severe pressure drop in the compressed-air supply 6, a pressure monitor 14 is arranged in the compressed-air supply 6 and signals to the position regulator 8, via a signal input 15, when a minimum pressure is undershot. The position regulator 8 then ends its regulation function and, instead of this, blocks the pressurization and depressurization of the pneumatic drive 2. Alternatively, a position limit-value signaling device 16 can be provided, which signals to the position regulator 8 via the signal input 15 when the actual position of the valve 1 deviates excessively from the nominal value sₙₒₘ.

The partial stroke test can be initiated manually and selectively via a control element 17, by means of a binary signal at a signal input 18 of the position regulator 8 or at regular intervals by means of a timer 19 which is contained in the position regulator 8.

In order to evaluate the partial stroke test, the position regulator 8 contains an evaluation device 20 which displays the test result on a display 21 and/or signals it to the control system 5 via a preferably binary signal output 22. The actual positions of the valve 1 recorded during the partial stroke test are stored in a memory 23 in the position regulator 8 for diagnosis purposes. However, the actual position reached during the partial stroke test can also be signaled via a position signaling device 24 for example in the form of a proximity switch.

When a communication interface such as HART or fieldbus is provided, the start of the partial stroke test and the reading of the test results can be used for further evaluation, visualization or archiving, as well.

1.-12. (canceled)

13. An actuating device for an on/off valve, comprising:
a control system for supplying a control voltage;
a pneumatic drive which is pressurized or depressurized as a function of a presence or absence of the control voltage supplied by the control system, the pneumatic drive moving on/off the valve to an operating position when pressurized and moving the on/off valve to a safe position when depressurized; and
an electropneumatic position regulator connected directly to the pneumatic drive, without interposition of a solenoid valve which can be controlled by the control voltage, the electropneumatic position regulator performing a partial stroke test by temporarily moving the on/off valve over a part of an actuating movement of the on/off valve at a nominal position, recording an actual position of the on/off valve, and producing a pneumatic manipulated variable for the pneumatic drive as a function of the actual position and the nominal position of the on/off valve;
wherein the position regulator is connected on the power supply side to the control voltage which is suppliable by the control system and is configured to depressurize the pneumatic drive upon power supply failures; and
wherein a routine for performing the partial stroke test and a value indicating the nominal position of the on/off valve in the operating position are stored in the position regulator.

14. The actuating device as claimed in claim 13, wherein the nominal position of the on/off valve in the operating position is proximate an end stop of the on/off valve in the operating position.

15. The actuating device as claimed in claim 14, wherein a distance between the end stop of the on/off valve and the operating position is 3% of the distance between the end stop and the safe position.

16. The actuating device as claimed in claim 13, wherein the position regulator includes a control element for initiating the partial stroke test.

17. The actuating device as claimed in claim 14, wherein the position regulator includes a control element for initiating the partial stroke test.

18. The actuating device as claimed in claim 13, wherein the position regulator includes a signal input for initiating the partial stroke test.

19. The actuating device as claimed in claim 18, wherein the signal input is a binary input.

20. The actuating device as claimed in claim 13, wherein the position regulator includes a timer for initiating the partial stroke test at regular time intervals.

21. The actuating device as claimed in claim 13, wherein the position regulator includes a memory for storing actual positions of the valve recorded during the partial stroke test.

22. The actuating device as claimed in claim 13, wherein the position regulator includes an evaluation device for evaluating the partial stroke test, and provides a signal output for signaling a result of the partial stroke test.

23. The actuating device as claimed in claim 22, wherein the signal output is a binary output.

24. The actuating device as claimed in claim 13, wherein a position signal is generated for signaling the actual position reached during the partial stroke test.

25. The actuating device as claimed in claim 13, further comprising:
a pressure monitor which is arranged for monitoring a compressed-air supply for the position regulator;
wherein pressure monitor is connected to a signal input of the position regulator, and wherein the position regulator is configured to set position regulation, when a minimum pressure is undershot, and block pressurization and depressurization of the pneumatic drive.

26. The actuating device as claimed in claim 13, further comprising:
a position limit-value signaling device connected to a signal input of the position regulator for signaling an actual position of the valve other than the operating position;
wherein the position regulator is configured to set position regulation if a position discrepancy is exceeded, and wherein the position regulator blocks pressurization and depressurization of the pneumatic drive.
